(19) United States
(12) Patent Application Publication
(10) Pub. No.: US 2022/0214012 A1
(43) Pub. Date: Jul. 7, 2022

(54) LUBRICATION APPARATUS

(71) Applicant: Honda Motor Co., Ltd., Tokyo (JP)

(72) Inventors: Benjamin B. Macarthur, Barrie (CA); Matthew Gowthorpe, Burlington (CA); Carrie-Anne Nolan, Alliston (CA); Zachary Elman, Toronto (CA)

(21) Appl. No.: 17/141,822

(22) Filed: Jan. 5, 2021

(51) Int. Cl. F16N 13/16; F16N 7/16; F16N 31/00; F16N 33/00

(52) U.S. Cl. CPC F16N 13/16; F16N 7/16; F16N 2270/22; F16N 33/00; F16N 31/00

(57) ABSTRACT

A lubrication apparatus for a component is provided. The lubrication apparatus includes a base positioned on a support. The lubrication apparatus further includes a chamber disposed on a first portion of the base. The chamber includes a lubrication section and a first storage section coupled to the lubrication section. The lubrication apparatus further includes a first sensor unit disposed on a second portion of the base. The lubrication apparatus further includes a fluid actuation mechanism coupled to the first sensor unit. The fluid actuation mechanism includes an actuation member disposed in the first storage section.

### BACKGROUND

Lubrication is a well-known process to reduce friction, wear, and tear of components which may come in contact during installation or during use. In some instances, a spray mister may be used as a lubrication device to lubricate components. The spray mister may mix oil with pressurized air to form an airborne spray mix, which may be sprayed on a target component. This mix may not fully lubricate the target component all the way around. There may be spots on the target component which may be dry and other spots which may be wet. In some instances, a sponge soaked in a lubricant fluid may be dabbed on the target component to lubricate the component. At times, the sponge may trap debris, which may contaminate the surface of the target component during lubrication.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides a lubrication apparatus. The lubrication apparatus may include a base positioned on a support and a chamber disposed on a first portion of the base. The chamber may include a lubrication section and a first storage section coupled to the lubrication section. The lubrication apparatus may further include a first sensor unit disposed on a second portion of the base and a fluid actuation mechanism coupled to the first sensor unit. The fluid actuation mechanism may include a first actuation member that may be disposed in the first storage section. When a component is placed in the lubrication section, the component may apply a downward force on the base against the support. The downward force may cause the first sensor unit to actuate the first actuation member for a first period, to transfer a first portion of a lubricant fluid stored in the first storage section to the lubrication section, to lubricate a first part of the component by the transferred first portion of the lubricant fluid.

Another exemplary aspect of the disclosure provides a lubrication apparatus. The lubrication apparatus may include a base positioned on a support and a chamber disposed on a first portion of the base. The chamber may include a lubrication section and a first storage section coupled to the lubrication section. The lubrication apparatus may further include a first sensor unit disposed on a second portion of the base and a fluid actuation mechanism coupled to the first sensor unit. The fluid actuation mechanism may include an actuation member disposed in the first storage section.

Another exemplary aspect of the disclosure provides a method for lubricating a part of a component. The method may include disposing a lubrication apparatus which includes a base positioned on a support. The lubrication apparatus may further include a chamber disposed on a first portion of the base. The chamber may include a lubrication section and a first storage section coupled to the lubrication section. The lubrication apparatus may further include a first sensor unit disposed on a second portion of the base and a fluid actuation mechanism coupled to the first sensor unit. The fluid actuation mechanism may include a first actuation member disposed in the first storage section. The method may further include placing the component in the lubrication section such that the component may apply a downward force on the base against the support. The downward force may cause the first sensor unit to actuate the first actuation member for a first period to transfer a first portion of a lubricant fluid stored in the first storage section to the lubrication section. The first part of the component may be lubricated by the transferred first portion of the lubricant fluid. The method may further include removing the component from the lubrication section after the first part is lubricated.

This summary is provided to introduce a selection of concepts in a simplified form that are further disclosed in the detailed description of the present disclosure. This summary is not intended to identify key or essential inventive concepts of the claimed subject matter, nor is it intended for determining the scope of the claimed subject matter.

### BRIEF DESCRIPTION OF THE DRAWINGS

FIG. 1 is a diagram that illustrates a perspective view of an exemplary lubrication apparatus, in accordance with an embodiment of the disclosure.

FIG. 2 is a diagram that illustrates a front view of the exemplary lubrication apparatus of FIG. 1, in accordance with an embodiment of the disclosure.

FIG. 3 is a diagram that illustrates exemplary operations for lubricating a component by the exemplary lubrication apparatus of FIG. 1, in accordance with an embodiment of the disclosure.

FIG. 4 is a diagram that illustrates an exemplary implementation for the lubrication apparatus of FIG. 1 for a cleaning operation, in accordance with an embodiment of the disclosure.

FIG. 5 is a flowchart that illustrates an exemplary method for lubricating a part of a component, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may provide a lubrication apparatus for lubricating a part (for example, O-rings) of a component, for example, a Heat and Air Conditioning pipe (HAC pipe). The lubrication apparatus may include a base positioned on a support. For example, the support may be a floating pneumatic cylinder, which may compensate any misalignment (such as wobbling) of the lubrication apparatus and may impart a balance and stability to the lubrication apparatus. The lubrication apparatus may further include a chamber (for example, a lubricant fluid tank) disposed on the base. The chamber may include a lubricating section and a first storage section coupled to the lubricating section, to form a substantially inverted U-shaped structure. The inverted U-shaped structure of the chamber may include a parallelly disposed point load on either sides of the inverted U-shaped structure. Such parallelly disposed point load may facilitate a uniformly distributed load of a lubricant fluid (such as mineral oils, or synthetic oils, such as esters and alkylbenzenes) in the chamber and may further impart balance and stability to the lubrication apparatus.

The lubrication apparatus may further include a fluid actuation mechanism coupled to a first sensor unit (such as a transducer) that may be disposed on the base. The fluid actuation mechanism may include a first actuation member (such as a piston) that may be disposed in the first storage section. Based on signals from the first sensor unit, the first actuation member may be configured to actuate (for example, move forward) and transfer a first portion of the lubricant fluid stored in the first storage section to the lubrication section, to lubricate a first part (for example, O-rings) of the component by the transferred first portion of the lubricant fluid. Upon lubrication, there may be no dry spots on the first part of the component.

The lubrication apparatus may further include a cleaning mechanism that may be coupled with the chamber to release a cleaning fluid inside the lubrication section. When released, the cleaning fluid may clean an excess amount of the lubrication fluid accumulated on one or more parts of the component. Therefore, the cleaning mechanism may ensure no loose debris ends up on the first part (such as the O-rings) of the component.

Reference will now be made in detail to specific aspects or features, examples of which are illustrated in the accompanying drawings. Wherever possible, corresponding, or similar reference numbers will be used throughout the drawings to refer to the same or corresponding parts.

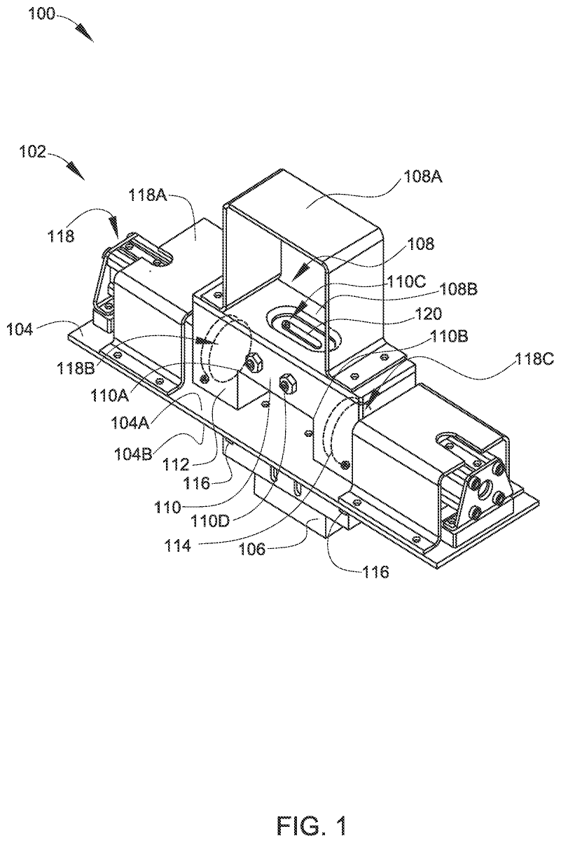

FIG. 1 is a diagram that illustrates a perspective view of an exemplary lubrication apparatus, in accordance with an embodiment of the disclosure. With reference to FIG. 1, there is shown an exemplary view 100 of a lubrication apparatus 102. The lubrication apparatus 102 may include a base 104 positioned on a support 106 and a chamber 108 disposed on a first portion 104A of the base 104. The chamber 108 may include a lubrication section 110 and a first storage section 112. In an embodiment, the chamber 108 may also include a second storage section 114. The lubrication apparatus 102 may further include a first sensor unit 116 that may be disposed on a second portion 1046 of the base 104 and a fluid actuation mechanism 118 coupled to the first sensor unit 116.

The base 104 may have a suitable structure, design, or a shape profile that may be configured to support at least one of: the chamber 108, the first sensor unit 116, and the fluid actuation mechanism 118 of the lubrication apparatus 102. In an embodiment, the base 104 (for example, a plate) may have a substantially rectangular structure or a substantially circular structure.

The support 106 may have a suitable structure, design, or shape that may be configured to hold the base 104 in position. In an embodiment, the support 106 may include any substructure to hold the base 104 in position. Examples of the support 106 may include, but are not limited to, a floating pneumatic cylinder, a floating hydraulic cylinder, or a floating mechanical cylinder. In an embodiment, the support 106 may be a floating air cylinder (controlled by a precision regulator) that may compensate any misalignment (such as wobbling) of the lubrication apparatus 102 and may impart a balance and stability to the lubrication apparatus 102. The support 106 may be adjustable in height to allow a user or an associate to comfortably place components (which have to be lubricated) inside the chamber 108 of the lubrication apparatus 102.

The chamber 108 may be configured to rest on the base 104 and may have a suitable structure, design, or a shape profile to store the lubricant fluid. Also, the chamber 108 may provide a support on which any component (which is to be lubricated) may rest. The chamber 108 may be shaped to a substantially inverted U-shaped structure or any suitable structure, such as, but not limited to, a H-shaped structure or a N-shaped structure. The inverted U-shaped structure of the chamber 108 may uniformly distribute a load of the lubricant fluid in the chamber 108 and may impart a balance and stability to the lubrication apparatus 102.

The lubrication section 110 may have a suitable structure, design, or shape profile that may be configured to receive a component in the lubrication section 110 for lubrication. The lubrication section 110 may be disposed at a mid-section 108B of the chamber 108. In an embodiment, the lubrication section 110 may have a substantially rectangular structure, as shown in FIG. 1. Alternatively, the lubrication section 110 may have any other structure, such as, but not limited to, a substantially circular or cylindrical structure or a substantially polygonal structure.

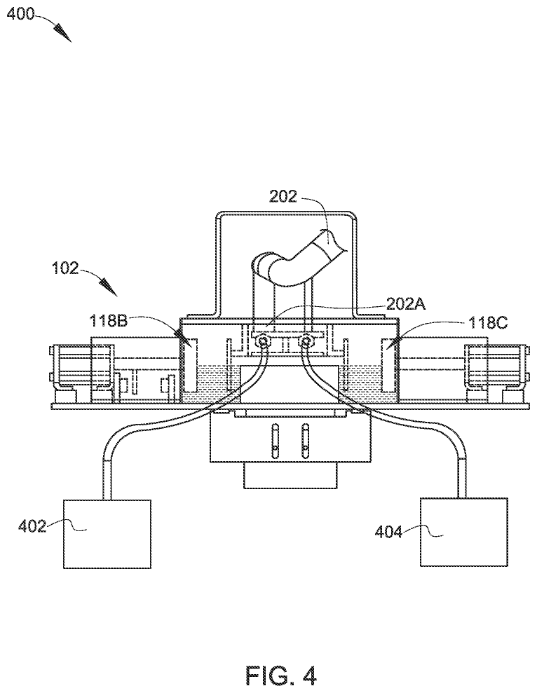

In an embodiment, the lubrication section 110 may include a first end 110A, a second end 1106, a slot 110C and a port 110D. The first end 110A of the lubrication section 110 may be opposite to the second end 1106 of the lubrication section 110. The slot 110C may be a cut-out in the lubrication section 110 to receive the component for lubrication. In an embodiment, the slot 110C may have a substantially rectangular profile or may have other profiles, such as a circular profile. The port 110D may be configured to be coupled with at least one of: a cleaning mechanism (shown in FIG. 4) or a suction mechanism (shown in FIG. 4), to clean one or more parts of the component after lubrication. Details of the cleaning mechanism and the suction mechanism are further described, for example in FIG. 4.

The first storage section 112 may have a suitable structure, design, or shape profile that may be configured to store the lubricant fluid. The first storage section 112 may have a substantially rectangular structure or may have any other structure, such as a substantially circular or cylindrical structure. The first storage section 112 may be coupled to the first end 110A of the lubrication section 110. In an embodiment, the lubrication section 110 may be at a first height from the base 104 and the first storage section 112 may be at a second height from the base 104. The first height may be greater than the second height.

Similar to the first storage section 112, the second storage section 114 may have a suitable structure, design, or a shape profile that may be configured to store the lubricant fluid. In an embodiment, the second storage section 114 may be coupled to the second end 1106 of the lubrication section 110. The second storage section 114 may have a substantially rectangular structure or may have any other structure, such as a substantially circular or cylindrical structure. In an embodiment, the second storage section 114 may be at a third height from the base 104. The third height may be less than the first height and may be equal to or different from the second height.

In an embodiment, the lubrication apparatus 102 may include a chamber enclosure 108A that may be configured to enclose and cover the chamber 108. In an embodiment, the chamber enclosure 108A may be fastened to the chamber 108. For example, the chamber enclosure 108A may be fastened in such a way that it may prevent any external debris from entering into the chamber 108. In another embodiment, the chamber enclosure 108A may extend from ends of the chamber 108. The chamber enclosure 108A may be contoured in such a way that it may cover the chamber 108 and any component which may be placed inside the chamber 108 for lubrication.

The first sensor unit 116 may be configured to detect a downward force that may be applied when the component is placed on the lubrication section 110. In an embodiment, the downward force may cause the first sensor unit 116 to actuate the fluid actuation mechanism 118. In an embodiment, the first sensor unit 116 may be disposed on the second portion 1046 of the base 104. In another embodiment, the first sensor unit 116 may be disposed between the support 106 and the second portion 1046 of the base 104. Examples of the first sensor unit 116 may include, but are not limited to, a pneumatic sensor, a piezoelectric transducer, a strain type compressive load cell, a shear beam load cell, a bending beam load cell, or a double ended shear beam load cell.

The fluid actuation mechanism 118 may be coupled to the first sensor unit 116 and may be configured to transfer a portion of the lubricant fluid stored in at least one of: the first storage section 112 or the second storage section 114, to the lubrication section 110. The fluid actuation mechanism 118 may include an enclosure 118A, a first actuation member 118B, and a second actuation member 118C. The enclosure 118A may be affixed to the base 104 and may have a suitable structure, design, or a shape profile to enclose the first actuation member 118B. In an embodiment, another enclosure may enclose the second actuation member 118C or the enclosure 118A may extend to also enclose the second actuation member 118C.

The first actuation member 1186 may be disposed in the first storage section 112 and may be configured to actuate for a first period (for example, 3 seconds) to transfer a first portion of the lubricant fluid stored in the first storage section 112, to the lubrication section 110. In an embodiment, the first actuation member 1186 may be a first piston that may be disposed in the first storage section 112. In another embodiment, the first actuation member 1186 may be an actuation element other than the first piston, such as, but not limited to, a solenoid-actuated valve, a pilot operated valve, a three-way valve or a four-way valve. Similar to the first actuation member 118B, the second actuation member 118C may be disposed in the second storage section 114 and may be configured to actuate for the first period (for example, 3 seconds) to transfer a second portion of the lubricant fluid stored from the second storage section 114 to the lubrication section 110. In an embodiment, the second actuation member 118C may be a second piston that may be disposed in the second storage section 114. In another embodiment, the second actuation member 118C may be an actuation element other than the second piston, such as, but not limited to, a solenoid-actuated valve, a pilot operated valve, a three-way valve, or a four-way valve.

In operation, the component may be placed in the lubrication section 110. For example, an associate may place the component in the lubrication section 110 and may press down for the base 104 to trigger the first sensor unit. This may be done instead of a foot pedal mechanism so that the associate is right by the lubrication apparatus 102 when completing the lubrication process and cannot simply press a foot pedal without the pipe being inside the lubrication section 110. When the component is placed in the lubrication section 110, the component may apply a downward force on the base 104 against the support 106.

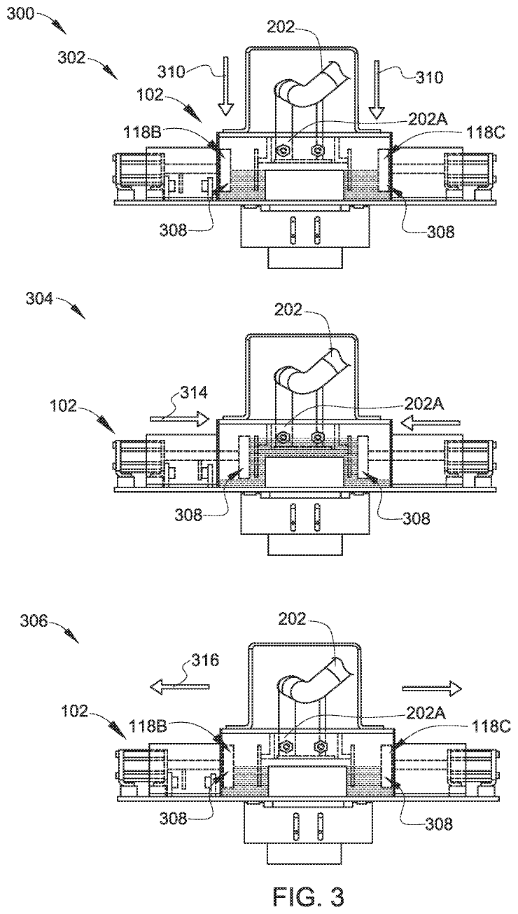

In one embodiment, the downward force may cause the first sensor unit 116 to actuate the first actuation member 118B for a first period (for example, 3 seconds). The first actuation member 1186 may be actuated to transfer a first portion of the lubricant fluid stored in the first storage section 112 to the lubrication section 110. In an embodiment, the downward force may cause the first sensor unit 116 to also actuate the second actuation member 118C. Similar to the actuation of the first actuation member 1186, the second actuation member 118C may be actuated to transfer a second portion of the lubricant fluid stored in the second storage section 114 to the lubrication section 110. The transferred first portion (and the second portion) of the lubricant fluid may lubricate a part of the component placed in the lubrication section 110. The above process be performed with a minimal human intervention (which may include an act of lifting and placing the component in the lubrication section 110 and removal of the component from the lubrication section 110 after the part of the component is lubricated). Details of the lubrication process are further explained, for example in FIG. 3.

In an embodiment, the component may be pressed down onto a gasket 120 disposed inside the lubrication section 110. The gasket 120 may seal at least one opening of the component to prevent the transferred first portion (and/or the second portion) of the lubricant fluid from leaking inside at least one opening of the component. In an embodiment, the gasket 120 may be located beneath the slot 110C of the lubrication section 110 and may be configured to receive the component and mate with the at least one opening of the component.

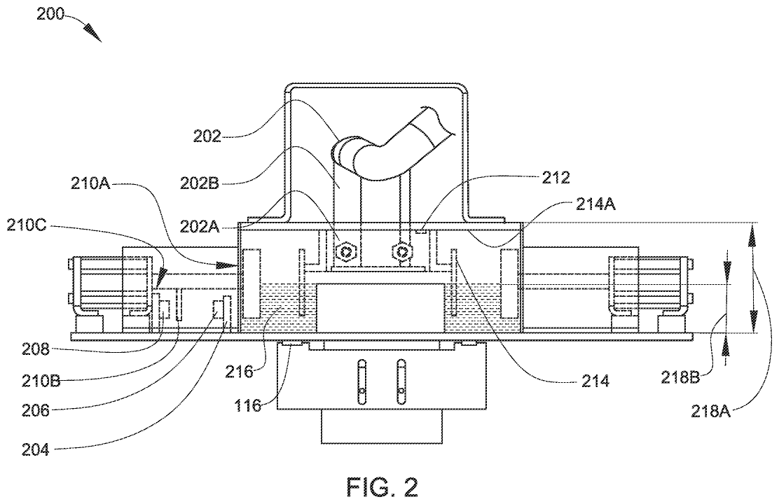

FIG. 2 is a diagram that illustrates a front view of the exemplary lubrication apparatus of FIG. 1, in accordance with an embodiment of the disclosure. FIG. 2 is explained in conjunction with elements from FIG. 1. With reference to FIG. 2, there is shown a front view 200 of the lubrication apparatus 102. In the front view 200, there is also shown a component 202, a first part 202A of which may have to be lubricated before the component 202 is installed in a target structure or assembly, such as a vehicle. For example, the component 202 may be a Heat and Air Conditioning (HAC) pipe, the first part 202A of which may include O-rings.

In the front view 200, the fluid actuation mechanism 118 includes a time delay valve 204 and a second sensor unit 206 coupled to the time delay valve 204. The time delay valve 204 may be coupled to the first actuation member 1186. Specifically, the time delay valve 204 may be located on a cap end 210A of the first actuation member 1186. In an embodiment, the time delay valve 204 may be also coupled to the second actuation member 118C. Examples of the time delay valve 204 may include, but not limited to, a normally-closed time delay valve or a normally-open time delay valve.

The second sensor unit 206 may be disposed in the chamber 108. Specifically, the second sensor unit 206 may be disposed in the cap end 210A of the first actuation member 1186. The second sensor unit 206 may be configured to signal the time delay valve 204 to hold the first actuation member 1186 in an actuated state (as shown in FIG. 3) for a first period (for example, 3 seconds). In an embodiment, the time delay valve 204 may include an air reservoir (not shown). A time period that may be required to fill the air reservoir through a pneumatic supply may be determined to set the first period. In an embodiment, the time delay valve 204 may be signaled to also hold the second actuation member 118C in the actuated state. Examples of the second sensor unit 206 may include, but are not limited to, a proximity sensor, an optical sensor, an ultrasonic sensor, or a hall-effect sensor.

The lubrication apparatus 102 may further include a third sensor unit 208, an activation part 210B of the first actuation member 118B, a fourth sensor unit 212, and a fluid barrier 214. The third sensor unit 208 may be configured to signal a cleaning mechanism to initiate a cleaning operation (as described in FIG. 4). In an embodiment, the translation of the activation part 210B may trigger the third sensor unit 208 to signal the cleaning mechanism to initiate the cleaning operation for a second period. In an embodiment, the third sensor unit 208 may be disposed in the chamber 108, for example, in a rod end 210C of the first actuation member 118B (which may be disposed inside the chamber 108). Examples of the third sensor unit 208 may include, but are not limited to, a proximity sensor, an optical sensor, an ultrasonic sensor, or a hall-effect sensor.

The activation part 210B may have a suitable structure, design, or a shape profile that may be configured to translate between the second sensor unit 206 and the third sensor unit 208, based on a movement or translation of the first actuation member 118B. In an embodiment, the translation of the activation part 210B may trigger at least one of: the second sensor unit 206 or the third sensor unit 208. For example, if the activation part 210B translates towards the cap end 210A of the first actuation member 118B, the second sensor unit 206 may be triggered. Similarly, if the activation part 210B translates towards the rod end 210C of the first actuation member 118B, the third sensor unit 208 may be triggered. Based on the translation of the activation part 210B, the transfer of lubricant fluid 216 may be controlled.

The fourth sensor unit 212 may be configured to signal a suction mechanism (described in FIG. 4) to initiate a suction operation (such as a suction of excess of the lubricant fluid 216 on one or more parts of the component 202). Based on a completion of the cleaning operation in the lubrication section 110, the lubrication apparatus 102 may be configured to actuate the fourth sensor unit 212. In an embodiment, the translation of the activation part 210B may trigger the fourth sensor unit 212 to signal the suction mechanism to initiate the suction operation for a third period. In an embodiment, the fourth sensor unit 212 may be disposed in a top surface 214A of the lubrication section 110. Examples of the fourth sensor unit 212 may include, but are not limited to, a flow sensor, a pressure level sensor, an ultrasonic level sensor, a radar level sensor, or even a float switch, which may initiate the suction operation. Details of the suction operation is further explained, for example in FIG. 4.

The fluid barrier 214 may have a suitable structure, design, or a shape profile that may be configured to segregate the lubrication section 110 from the at least one of: the first storage section 112 or the second storage section 114. In an embodiment, the fluid barrier 214 may be spaced from the first end 110A of the lubrication section 110. In another embodiment, the fluid barrier 214 may be spaced from the second end 1106 of the lubrication section 110. In another embodiment, the fluid barrier 214 may be spaced from both the first end 110A and the second end 1106 of the lubrication section 110. The fluid barrier 214 may have a substantially L-shaped structure that may be coupled to the top surface 214A of the lubrication section 110.

The lubricant fluid 216 may fill the first storage section 112 and the second storage section 114. Examples of the lubrication fluid 216 may include, but are not limited to, mineral oil, synthetic oil (such as esters and alkylbenzenes), and Poly-Alkylene Glycol (PAG oil). In an embodiment, the lubrication section 110 may be disposed at a first height 218A from the base 104 and the first storage section 112 may be disposed at a second height 2186 from the base 104. The first height 218A may be greater than the second height 218B.

FIG. 3 is a diagram that illustrates exemplary operations for lubricating a component by the exemplary lubrication apparatus of FIG. 1, in accordance with an embodiment of the disclosure. FIG. 3 is explained in conjunction with elements from FIG. 1 and FIG. 2. With reference to FIG. 3, there is shown an exemplary scenario 300 that may depict a sequence of exemplary states of the lubrication apparatus 102. The sequence of exemplary states may include a default state 302, an actuated state 304, and a reset state 306.

In the default state 302, the first actuation member 1186 may be disposed in the first storage section 112 in a default position 308. For example, the first actuation member 118B may be disposed adjacent to the first end 110A of the lubrication section 110 in the default position 308. In an embodiment, the activation part 2106 of the first actuation member 1186 may be positioned adjacent to the second sensor unit 206 in the default position 308. Further, the second actuation member 118C may be disposed in the second storage section 114 in the default position 308. For example, the second actuation member 118C may be located proximally to the second end 1106 of the lubrication section 110 in the default position 308.

In the default state 302, the lubricant fluid 216 may be stored in at least one of: the first storage section 112 and the second storage section 114. When the component 202 is placed in the lubrication section 110, the component 202 may apply a downward force 310 on the base 104 against the support 106. In some instances, the associate who may place the component 202 in the lubrication section 110 may press the component 202 down against the support 106 (for example, a floating air cylinder). The downward force 310 may cause the first sensor unit 116 to actuate the first actuation member 1186 and/or the second actuation member 118C.

In the actuated state 304, the first sensor unit 116 may actuate the first actuation member 118B. Also, the first sensor unit 116 may actuate the second actuation member 118C. As shown, for example, the first sensor unit 116 may trigger the first actuation member 118B to shift from the default position 308 to an extended position 312. Specifically, the first actuation member 118B may move along a forward direction 314 to shift from the default position 308 to the extended position 312.

While the first actuation member 1186 may be actuated for a first period to transfer a first portion of the lubricant fluid 216 stored in the first storage section to the lubrication section 110, the second actuation member 118C may also be actuated for the first period to transfer a second portion of the lubricant fluid 216 stored in the second storage section to the lubrication section 110. The first part 202A of the component 202 may be lubricated by the transferred first portion and the second portion of the lubricant fluid 216. When the first actuation member and/or the second actuation member are in the actuated state, a part (such as the activation part 2106) of the first actuation member may trigger the second sensor unit to signal the time delay valve to hold the first actuation member and/or the second actuation member in the actuated state for the first period.

In some embodiments, the first actuation member 1186 may be a first piston that may be disposed in the first storage section 112, and the actuation of the first actuation member 1186 may include an extension of the first piston along the forward direction 314 in the first storage section 112 from the default position 308 to the extended position 312. The extension of the first piston may transfer the first portion of the lubricant fluid 216 from the first storage section 112 to the lubrication section 110. Similarly, the second actuation member 118C may be a second piston that may be disposed in the second storage section 114, and the actuation of the second actuation member 118C may include an extension of the second piston from the default position 308 to the extended position 312. The extension of the second piston may transfer the second portion of the lubricant fluid 216 from the second storage section 114 to the lubrication section 110. In these or other embodiments, the first piston and the second piston may be configured to extend simultaneously from the default position 308 to the extended position 312 when the first actuation member 118B and the second actuation member 118C are actuated.

In the reset state 306, the first actuation member 1186 may be configured to reset in the first storage section 112 to the default state 302, which existed prior to the actuation of the first actuation member 118B. Similarly, the second actuation member 118C may be configured to reset in the second storage section 114 to the default state 302, which existed prior to the actuation of the second actuation member 118C. In an embodiment, the reset of the first actuation member 1186 or the second actuation member 118C may be performed based on the completion of the first period. The reset of the first actuation member 1186 may cause the transferred first portion of the lubricant fluid 216 to flow back from the lubrication section 110 to the first storage section 112. Similarly, the second portion of the lubricant fluid 216 may flow back from the lubrication section 110 to the second storage section 114. In an embodiment, the first portion of the lubricant fluid 216 may flow back (for example, caused by the force of gravity) from the lubrication section 110 to the first storage section 112. The flow may be based on a difference between the first height 218A of the lubrication section 110 and the second height 2186 of the first storage section 112. Similarly, a difference between the first height 218A of the lubrication section 110 and the second height 2186 of the second storage section 114 may cause the second portion of the lubricant fluid 216 to flow back (by the force of gravity) to the second storage section 114.

In some embodiments, the first actuation member 1186 may be the first piston that may be disposed in the first storage section 112 and the reset of the first actuation member 1186 to the default state 302 may include a retraction of the first piston in a reverse direction 316 in the first storage section 112 from the extended position 312 to the default position 308. The retraction of the first piston may transfer the first portion of the lubricant fluid 216 from the lubrication section 110 to the first storage section 112. In these or other embodiments, the second actuation member 118C may be the second piston that may be disposed in the second storage section 114 and the reset of the second actuation member 118C to the default state 302 may include a retraction of the second piston in the second storage section 114 from the extended position 312 to the default position 308. The retraction of the second piston may transfer the second portion of the lubricant fluid 216 from the lubrication section 110 to the second storage section 114. Upon retraction of the first piston and the second piston to the default position 308, the lubrication apparatus 102 may initiate a cleaning operation, as described in FIG. 4, for example.

FIG. 4 is a diagram that illustrates an exemplary implementation for the lubrication apparatus of FIG. 1 for a cleaning operation, in accordance with an embodiment of the disclosure. FIG. 4 is explained in conjunction with elements from FIG. 1, FIG. 2, and FIG. 3. With reference to FIG. 4, there is shown an exemplary scenario 400 for cleaning the component 202 inside the lubrication apparatus 102 after the first part 202A is lubricated. The lubrication apparatus 102 may include a cleaning mechanism 402 and a suction mechanism 404.

The cleaning mechanism 402 may be configured to clean an excess amount of the lubrication fluid 216 that may accumulate on one or more parts of the component 202 (during the actuated state 304 and the reset state 306). In one embodiment, the cleaning mechanism 402 may be coupled to a first opening 406 of the port 110D of the lubrication section 110.

The cleaning mechanism 402 may be a pneumatic cleaning mechanism (for example, an air blower), which may be configured to blow-off the excess amount of the lubrication fluid 216 that may be accumulated on one or more parts of the component 202. In an embodiment, the cleaning mechanism 402 may include a flow control valve (not shown) that may be coupled to the third sensor unit 208 disposed in the chamber 108. When the first actuation member 1186 resets to the default state 302, a part (such as the activation part 210B) of the first actuation member 118B may trigger the third sensor unit 208 to signal the flow control valve to release a cleaning fluid for a second period inside the lubrication section 110, to clean the excess amount of the lubrication fluid 216 accumulated on one or more parts of the component 202. In an embodiment, the cleaning fluid may be released as a jet of pressurized air. The jet of pressurized air may be released from a pneumatic cylinder associated with the cleaning mechanism 402. In an embodiment, the pneumatic cylinder may be a part of the cleaning mechanism 402. In another embodiment, the pneumatic cylinder may be remotely coupled to the cleaning mechanism 402. Upon blowing-off the excess amount of the lubricant fluid 216, the lubrication apparatus 102 may initiate the suction mechanism 404 to further clean the component 202 located in the lubrication section 110.

The suction mechanism 404 may be configured to suck out a portion of the transferred first portion, which may be accumulated on at least one of: an interior of the lubrication section 110 or the one or more parts of the component 202. In an embodiment, the suction mechanism 404 may be disposed in the lubrication section 110. In another embodiment, the suction mechanism 404 may be coupled to a second opening 408 of the port 110D of the lubrication section 110. The suction mechanism 404 may be a vacuum pump, which may be configured to suck out the portion of the transferred first portion of the lubricant fluid 216, accumulated on at least one of: the interior of the lubrication section 110 or the one or more parts of the component 202.

In an embodiment, the suction mechanism 404 may include a suction element (such as a vacuum pump) that may be coupled to the fourth sensor unit 212 disposed in the chamber 108. Based on a completion of the second period, the suction mechanism 404 may be configured to operate for a third period to suck out the portion of the transferred first portion, which may accumulate on at least one of: the interior of the lubrication section 110 or the one or more parts of the component 202. For example, when the first actuation member 118B resets to the default state 302, the fourth sensor unit 212 may signal the suction element to suck out the portion of the transferred first portion from the lubrication section 110 for the third period, to suck out the portion of the transferred first portion, accumulated on at least one of: the interior of the lubrication section 110 or the one or more parts of the component 202. Upon sucking out the portion of the transferred first portion of the lubricant fluid 216, the component 202 may be removed from the lubrication apparatus 102.

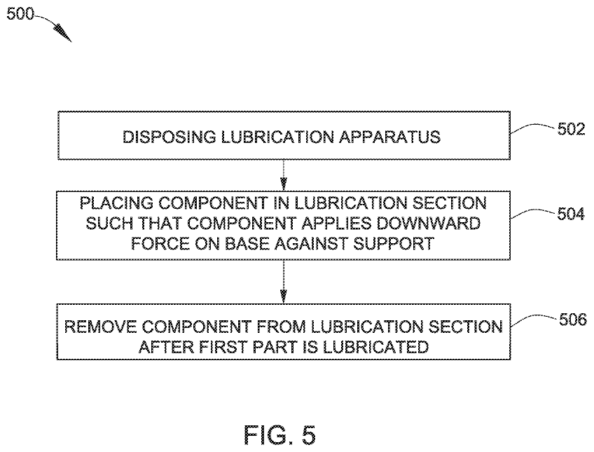

FIG. 5 is a flowchart that illustrates an exemplary method for lubricating a part of a component, in accordance with an embodiment of the disclosure. FIG. 5 is explained in conjunction with elements from FIGS. 1, 2, 3, and 4. With reference to FIG. 5, there is shown a flowchart 500 that depicts a method of lubricating the component 202 as shown in FIGS. 2 and 3. The method illustrated in the flowchart 500 may start from 502.

At 502, the lubrication apparatus 102 may be disposed. In an embodiment, the user may dispose the lubrication apparatus 102 to perform the lubrication operation on the component 202, as described in FIGS. 1, 2 and 3.

At 504, the component 202 may be placed in the lubrication section 110 such that the component 202 applies a downward force on the base 104 against the support 106. Thereafter, the lubrication apparatus 102 may operate (as described in FIG. 3) to lubricate the first part 202A of the component 202.

At 506, the component 202 may be removed from the lubrication section 110 after the first part 202A of the component 202 is lubricated. For example, the user may remove the component 202 from the lubrication section 110 after the first part 202A of the component 202 is lubricated.

The flowchart 500 is illustrated as discrete operations, such as 502, 504, and 506. However, in certain embodiments, such discrete operations may be further divided into additional operations, combined into fewer operations, or eliminated, depending on the implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure may not limited to the particular embodiment disclosed, but that the present disclosure will include all embodiments that fall within the scope of the appended claims.

What is claimed is:

1. A lubrication apparatus, comprising:
a base positioned on a support;
a chamber disposed on a first portion of the base, the chamber comprising:
a lubrication section; and
a first storage section coupled to the lubrication section;
a first sensor unit disposed on a second portion of the base; and
a fluid actuation mechanism coupled to the first sensor unit, the fluid actuation mechanism comprising a first actuation member disposed in the first storage section,
wherein when a component is placed in the lubrication section, the component applies a downward force on the base against the support, and
wherein the downward force causes the first sensor unit to actuate the first actuation member for a first period to transfer a first portion of a lubricant fluid stored in the first storage section to the lubrication section, and
a first part of the component is lubricated by the transferred first portion of the lubricant fluid.

2. The lubrication apparatus according to claim 1, wherein the fluid actuation mechanism further comprises a time delay valve coupled to the first actuation member, and wherein the time delay valve is configured to hold the first actuation member in an actuated state for the first period.

3. The lubrication apparatus according to claim 2, wherein the fluid actuation mechanism further comprises a second sensor unit, the second sensor unit is disposed in the chamber, and wherein
when the first actuation member is in the actuated state, a part of the first actuation member triggers the second sensor unit to signal the time delay valve to hold the first actuation member in the actuated state for the first period.

4. The lubrication apparatus according to claim 1, wherein the first actuation member is a first piston that is disposed in the first storage section, and the actuation of the first actuation member comprises an extension of the first piston in the first storage section from a default position to an extended position.

5. The lubrication apparatus according to claim 1, wherein based on a completion of the first period, the first actuation member is configured to reset in the first storage section to a default state which existed prior to the actuation of the first actuation member, and
wherein the reset of the first actuation member causes the transferred first portion of the lubricant fluid to flow back from the lubrication section to the first storage section.

6. The lubrication apparatus according to claim 5, wherein the lubrication section is at a first height from the base and the first storage section is at a second height from the base,
wherein the first height is greater than the second height, and
wherein a difference between the first height and the second height further causes the transferred first portion of the lubricant fluid to flow back from the lubrication section to the first storage section.

7. The lubrication apparatus according to claim 5, wherein the first actuation member is a first piston that is disposed in the first storage section, and
the reset of the first actuation member to the default state comprises a retraction of the first piston in the first storage section from an extended position to a default position.

8. The lubrication apparatus according to claim 5, further comprising a cleaning mechanism comprising a flow control valve coupled to a third sensor unit disposed in the chamber, wherein
when the first actuation member resets to the default state, a part of the first actuation member triggers the third sensor unit to signal the flow control valve to release a cleaning fluid for a second period inside the lubrication section, to clean an excess amount of the lubrication fluid accumulated on one or more parts of the component.

9. The lubrication apparatus according to claim 8, wherein the cleaning fluid is released as a jet of pressurized air.

10. The lubrication apparatus according to claim 8, further comprising a suction mechanism disposed in the lubrication section, wherein based on a completion of the second period, the suction mechanism is configured to operate for a third period to suck out a portion of the transferred first portion which accumulates on at least one of:
an interior of the lubrication section or the one or more parts of the component.

11. The lubrication apparatus according to claim 1, wherein
the component is pressed down onto a gasket disposed inside the lubrication section, and
the gasket seals at least one opening of the component to prevent the transferred first portion of the lubricant fluid from leaking inside the at least one opening.

12. The lubrication apparatus according to claim 1, wherein the support is a floating pneumatic cylinder, and
wherein the first sensor unit is disposed between the floating pneumatic cylinder and the second portion of the base.

13. The lubrication apparatus according to claim 1, wherein the first storage section is coupled to a first end of lubrication section, and the chamber further comprises a second storage section coupled to a second end of the lubrication section.

14. The lubrication apparatus according to claim 13, wherein the fluid actuation mechanism further comprises a second actuation member disposed in the second storage section,
wherein the downward force causes the first sensor unit to actuate the second actuation member for the first period to transfer a second portion of the lubricant fluid stored in the second storage section to the lubrication section, and
wherein the first part of the component is further lubricated by the transferred second portion of the lubricant fluid.

15. The lubrication apparatus according to claim 14, wherein the first actuation member is a first piston and the second actuation member is a second piston,
wherein the first piston and the second piston are configured to extend from a default position to an extended position when the first actuation member and the second actuation member are actuated.

16. The lubrication apparatus according to claim 1, wherein the component is a Heat and Air Conditioning (HAC) pipe and the first part to be lubricated is an O-ring.

17. A lubrication apparatus, comprising:
a base positioned on a support;
a chamber disposed on a first portion of the base, the chamber comprising:
a lubrication section; and
a first storage section coupled to the lubrication section;
a first sensor unit disposed on a second portion of the base; and
a fluid actuation mechanism coupled to the first sensor unit, the fluid actuation mechanism comprising an actuation member disposed in the first storage section.

18. The lubrication apparatus according to claim 17, further comprising a cleaning mechanism comprising a flow control valve coupled to a third sensor unit disposed in the chamber.

19. The lubrication apparatus according to claim 17, further comprising a suction mechanism disposed in the lubrication section.

20. A method of lubricating a part of a component, comprising:
disposing a lubrication apparatus, the lubrication apparatus comprising:
a base positioned on a support;
a chamber disposed on a first portion of the base, the chamber comprising:
a lubrication section; and
a first storage section coupled to the lubrication section;
a first sensor unit disposed on a second portion of the base; and
a fluid actuation mechanism coupled to the first sensor unit, the fluid actuation mechanism comprising a first actuation member disposed in the first storage section;
placing the component in the lubrication section such that the component applies a downward force on the base against the support, wherein
the downward force causes the first sensor unit to actuate the first actuation member for a first period to transfer a first portion of a lubricant fluid stored in the first storage section to the lubrication section, and
the first part of the component is lubricated by the transferred first portion of the lubricant fluid; and
removing the component from the lubrication section after the first part is lubricated.
